(19) United States
(12) Patent Application Publication
(10) Pub. No.: US 2025/0362430 A1
(43) Pub. Date: Nov. 27, 2025

(54) BEIDOU/GNSS-BASED REAL-TIME HIGH-ACCURACY SEA SURFACE MEASUREMENT METHOD AND BUOY

(71) Applicant: FIRST INSTITUTE OF OCEANOGRAPHY, MINISTRY OF NATURAL RESOURCES, Qingdao, Shandong (CN)

(72) Inventors: Yang LIU, Qingdao (CN); Fangli QIAO, Qingdao (CN); Yabin WANG, Qingdao (CN); Yanxiong LIU, Qingdao (CN); Yanfeng WANG, Qingdao (CN)

(73) Assignee: FIRST INSTITUTE OF OCEANOGRAPHY, MINISTRY OF NATURAL RESOURCES, Qingdao, Shandong (CN)

(21) Appl. No.: 18/874,778

(22) PCT Filed: Jul. 18, 2022
(86) PCT No.: PCT/CN2022/106279

§ 371 Date: Dec. 13, 2024

(30) Foreign Application Priority Data
Jul. 8, 2022 (CN) 202210807632.3

(51) Int. Cl. G01W 1/02; G01S 19/25; G01S 19/42

(52) U.S. Cl. CPC G01W 1/02; G01S 19/256; G01S 19/258; G01S 19/42

(57) ABSTRACT

A Beidou/GNSS-based real-time high-precision sea surface measurement method and a buoy, wherein by using free-to-use broadcast ephemeris freely broadcast by GNSS satellites, precise point positioning of China's Beidou satellites, and other high-precision service space signals, real-time centimeter-level element information comprising time, longitude, latitude, water level, wave height, wave period, wave direction, sea surface current velocity and direction, atmospheric water vapor content, and the like can be directly obtained. The information can be stored locally in a buoy or transmitted back by communication, and is suitable for real-time high-precision sea surface measurements in offshore and far-sea scenarios.

### TECHNICAL FIELD

The present invention relates to the field of environmental monitoring and marine navigation and positioning of all water environment scenes such as lakes, rivers, and oceans, and specifically relates to a GNSS-based real-time high-accuracy measurement method for a sea surface water level, ocean waves, ocean currents, and atmospheric water vapor content.

### BACKGROUND

A sea surface water level, ocean waves, ocean currents, and atmospheric water vapor content are important parameters for marine environmental monitoring. It is of great significance to monitor changes and study laws of these important parameters to human marine activities and disaster mitigation and prevention in the ocean and climate. In recent decades, with the continuous increase of human activities in ocean development, the research on sea surface observation methods and the development of instruments and equipment have been greatly promoted. At present, various sea surface measurement instruments such as a large hydrometeorological buoy, an accelerometer wave meter, and a GNSS buoy tide gauge have been emerged. A GNSS buoy uses a global navigation satellite system (GNSS) to obtain three-dimensional spatial position and time information of a buoy carrier, and has good continuous monitoring characteristics, so that the sea surface water level and the ocean waves can be effectively inverted based on the position information. Combined with an existing GNSS technology, the GNSS buoy can effectively observe the sea surface water level and the ocean waves, and has the advantages of a simple system, low cost, and a small size. For example, the First Institute of Oceanography of the Ministry of Natural Resources proposes a patent “Ocean Current Measurement Based on Surface Drifting Buoy” with an application number of 202111084002.X, in which four GNSS positioning modules need to be mounted, and an attitude sensor needs to be additionally mounted, but positioning accuracy of the buoy is only better than 0.6 m, and therefore, real-time positioning accuracy is low. The Ocean University of China proposes a patent “Blanket-mounted GNSS Buoy and Measurement Method for Measuring Two-dimensional Sea Surface Height” with an application number of 202111454338.0, in which an additional floating blanket to carry a GNSS antenna, the floating blanket is fixed on a rubber boat, the rubber boat is equipped with a GNSS receiver, and the floating blanket needs to be stable enough to keep its GNSS antenna level. A control system, a power supply system, and the like need to be mounted on an additional inflatable boat, to reduce the carrying weight of the floating blanket, and therefore, a plurality of additional devices are needed in this patent. In this patent, neither a GNSS positioning data processing method nor GNSS real-time positioning accuracy is described.

If the foregoing two technologies are to achieve real-time high-accuracy positioning, all buoy GNSS observations need to be sent back to a data processing center for real-time calculation, which requires a large amount of communication bandwidth, resulting in communication costs, especially high cost of ocean satellite communication, and reducing real-time performance of communication of ocean monitoring; or an additional real-time precise differential correction service is required, which greatly increases service cost and communication cost required for precise differential correction.

“A Method and System for Measuring River Current Velocity Based on GNSS-R Technology” with an application number of 201510121794.1 is a patented technology applied by the Space Science and Application Research Center of the Chinese Academy of Sciences, in which a received GNSS direct signal and a received GNSS reflected signal are down-converted and sampled through a GNSS direct signal antenna and a GNSS reflected signal antenna, and the GNSS reflected signal is processed to obtain a residual phase output value.

Centimeter-level-accuracy positioning results can be obtained by using a GNSS RTK (Real-Time Kinematic) real-time carrier phase differential technology and a PPK (Post-Processing Kinematic) dynamic post-processing differential technology. However, these methods all depend on a base station, and cannot be applied to a distant sea scene as an effective action distance is limited to a sea area within tens of kilometers from the shore.

A PPP precise point positioning (Precise Point Positioning) technology is not limited by a distance, and data does not need to be obtained from one or more close-range base stations. However, the accuracy of satellite orbits and clock error products is an important factor that affects the accuracy of PPP positioning. High-accuracy PPP depends on correction products such as a high-accuracy GNSS satellite orbit, and a clock error. The real-time high-accuracy PPP method requires an additional real-time precise differential correction product, which greatly increases the service cost and communication cost required for precise differential correction, and reduces application cost performance of a real-time scenario.

In conclusion, the existing GNSS-based sea surface measurement mainly has the following disadvantages:
(1) In order to achieve real-time centimeter-level sea surface measurement accuracy, all the buoy GNSS observations need to be sent back to the data processing center for real-time calculation, which requires a large amount of communication bandwidth, resulting in communication cost, especially high cost of ocean satellite communication, and reducing real-time performance of communication of ocean monitoring; and if the buoy GNSS observations are to be calculated in real time locally on the buoy, the additional differential correction service is required. The differential correction service needs to be obtained by communication with the land in the offshore area, and the differential correction service needs to be obtained from the communication satellite in the distant sea area, thereby increasing the cost of purchasing the differential correction service and communication.
(2) In order to achieve post-processing centimeter-level sea surface measurement accuracy, the buoy GNSS observation data needs to be sent back to the data processing center for post-processing calculation, which requires a large amount of communication bandwidth, resulting in communication cost, especially cost of distant-sea satellite communication; and if the GNSS data is read for calculation after the buoy is retrieved, the cost of the retrieving operation is increased, the degree of automation is poor, and the cost of the buoy to store a large amount of GNSS data is also increased.
(3) If the buoy GNSS observations are to be calculated in real time locally on the buoy, an additional differential correction service is required. The differential correction service needs to be obtained by communication with the land in the offshore area, and the differential correction service needs to be obtained from the communication satellite in the distant sea area, thereby increasing the cost of purchasing the differential correction service and communication.

From the above analysis, it is not difficult to understand that the current conventional GNSS sea surface measurement method has great disadvantages and limitations in real-time high-accuracy measurement. With the continuous development of GNSS technology, the bottleneck of the real-time high-accuracy sea surface measurement method is broken through; and the core of improving the real-time measurement timeliness of sea surface operations and the inversion accuracy of sea surface element parameters can directly provide technical support for inversion of the global ocean surface element information. At present, there is no technology for comprehensively measuring a plurality of elements such as a sea surface water level, ocean waves, ocean currents, and atmospheric water vapor content by using the method of this patent application.

### SUMMARY

In order to overcome the disadvantages in the above-mentioned technologies, the present invention provides a BeiDou/GNSS-based real-time high-accuracy sea surface measurement method and a buoy, which only need to carry one GNSS receiver (board card), and are commonly applicable to offshore and distant-sea scenarios. Real-time centimeter-level or decimeter-level buoy positions, and real-time high-accuracy sea surface measurement results including element information such as time, a longitude, a latitude, a water level, a wave height, a wave period, a wave direction, a current velocity and a current direction on a sea surface, and atmospheric water vapor content can be obtained by directly using a broadcast ephemeris that is freely broadcast and used by a GNSS satellite and a precise point positioning (PPP) service space signal PPP-B2b of the Chinese BeiDou satellite or a high-accuracy service HAS (High-Accuracy Service) space signal of the EU Galileo satellite or a centimeter-level augmentation service CLAS (Centimeter-Level Augmentation Service) space signal of the Japanese QZSS satellite, without purchasing an additional real-time precise differential correction service and communication thereof; and finally, the element information can be locally stored on the buoy or sent back through communication, so that the cost of purchasing an additional precise differential correction service, communication, and storage can be reduced.

An objective of the present invention is achieved by the following technical solution:
(1) adopting a buoy carried with a dual-frequency or multi-frequency GNSS to collect a high-frequency GNSS satellite positioning electrometric wave signal and a precise point positioning (PPP) service space signal PPP-B2b of the BeiDou satellite in real time, converting the high-frequency GNSS satellite positioning electrometric wave signal and the precise point positioning (PPP) service space signal of the BeiDou satellite into a phase, a pseudo range observation, a broadcast ephemeris and a correction number thereof, and sending the phase, the pseudo range observation, the broadcast ephemeris and the correction number thereof to a processor of the buoy;
(2) calculating in real time based on the broadcast ephemeris and the correction number thereof to obtain a GNSS precise satellite orbit, a clock error, a pseudo range bias, performing precise point positioning resolving, and resolving a longitude, a latitude, a geodetic height and a tropospheric delay of each epoch of a GNSS single antenna for considering processing an atmospheric delay error;
(3) returning to repeat steps (1) and (2) for 10-30 minutes to reach a specific data volume until initial convergence of precise point positioning is completed;
(4) resolving the longitude, the latitude, the geodetic height and the tropospheric delay of each epoch of the GNSS antenna in real time through precise point positioning; obtaining atmospheric water vapor content based on a zenith tropospheric delay estimated based on precise point positioning; resolving a three-dimensional velocity and a three-dimensional acceleration of the GNSS antenna through a phase epoch-difference observation equation by utilizing the precise satellite orbit and clock error that are calculated in real time, resolving attitude angles including a heading angle, a pitch angle, and a roll angle by using the GNSS single antenna, and calculating the geodetic height of each epoch, to obtain a water level based on the geodetic height of the GNSS antenna, the attitude angle, and a lever-arm vector from a static draught GNSS antenna to a water surface;
(5) repeating the steps (1) to (4) by using a sliding time window of 15-30 minutes, obtaining a wave height and period element information based on the geodetic height of each epoch of the GNSS antenna, or calculating a cross spectrum through a cross-correlation function based on displacements in vertical, east-west, and north-south directions of the GNSS antenna, then, obtaining a direction spectrum and a frequency spectrum of the ocean waves through a directional spectrum analysis method, so as to obtain a wave height, a period, and a wave direction; and obtaining an approximate mean current velocity and current direction on a sea surface by utilizing horizontal displacements and time intervals in east-west and north-south directions of the GNSS antenna within the sliding time window; and
(6) locally storing sea surface element information that is of sliding time window periods and that is calculated in real time on the buoy or performing real-time regular communication retransmission.

According to the present disclosure, in ocean measurement, the broadcast ephemeris that is freely broadcast and used by the GNSS satellite is used, and a GNSS signal collection module carried on the buoy is used to collect the GNSS phase, the pseudo range observation and the GNSS broadcast ephemeris, as well as the precise point positioning (PPP) service space signal PPP-B2b of the Chinese BeiDou satellite or the high-accuracy service HAS (High-Accuracy Service) space signal of the EU Galileo satellite or the centimeter-level augmentation service CLAS (Centimeter-Level Augmentation Service) space signal of the Japanese QZSS satellite.

According to the present disclosure, the GNSS real-time precise satellite orbit, the clock error, the pseudo range bias, and the like are calculated by utilizing the GNSS broadcast ephemeris and the precise point positioning (PPP) service space signal PPP-B2b of the BeiDou satellite. The longitude, the latitude, the geodetic height and the tropospheric delay of each epoch of the GNSS antenna are obtained through real-time precise point positioning resolving based on the precise satellite orbit and the clock error that are calculated in real time; the wave height and the period element information are obtained based on the information that the vertical displacement of the GNSS antenna changes with time, or the cross spectrum is calculated through the cross-correlation function based on the displacements in vertical, east-west, and north-south directions of the GNSS antenna, and then the direction spectrum and the frequency spectrum of the ocean waves are obtained through a directional spectrum analysis method, so as to obtain the wave height, the period, and the wave direction. The approximate mean current velocity and current direction on the sea surface are obtained by utilizing horizontal displacements and time intervals in east-west and north-south directions of the GNSS antenna within the sliding time window. The atmospheric water vapor content is obtained based on the zenith tropospheric delay estimated based on precise point positioning. The three-dimensional velocity of the GNSS antenna is resolved through the phase epoch-difference observation equation by utilizing the precise satellite orbit and the clock error that are calculated in real time. The attitude angles including the heading angle, the pitch angle, and the roll angle are resolved by using the GNSS single antenna, and the geodetic height of each epoch is calculated, to obtain the water level based on the geodetic height of the GNSS antenna, the attitude angle, and the lever-arm vector from the static draught GNSS antenna to the water surface.

According to the present disclosure, a real-time high-accuracy centimeter-level sea surface measurement result, and real-time high-accuracy centimeter-level or decimeter-level buoy positions may be further obtained through the GNSS centimeter-level augmentation service, the satellite station differential service, the precise positioning service, and the like that may be free in the future.

A corrected broadcast ephemeris is obtained by utilizing the BeiDou PPP-B2b signal, and parameters included in the satellite orbit and the clock error information of the corrected broadcast ephemeris are components of an orbit correction vector δ0 in a radial direction, a tangential direction, and a normal direction; and an orbit correction value is used to calculate a satellite position correction vector δX, and by jointly utilizing a satellite position vector X_{broadcast} that is calculated from the broadcast ephemeris, a correction value calculation formula is as shown in formula (7):

$${X}_{o r b i t} = {X}_{b r o a d cast} - δ X , \qquad ( 7 )$$

where
X_{orbit} is a satellite position obtained through correction based on an orbit correction message, X_{broadcast} is a satellite position calculated and obtained based on the broadcast ephemeris whose IOD is matched with IODN of the orbit correction message, and δX is a satellite position correction value.

A calculation method for the satellite position correction value δX is shown in formula (8) to formula (11):

$${e}_{radial} = \frac{r}{\vert r \vert} , \qquad ( 8 )$$

$$\text{?} = \frac{r \times \dot{r}}{\vert r \times \dot{r} \vert} , \qquad ( 9 )$$

$$\text{?} = {e}_{cross} \times {e}_{radial} , and \qquad ( 10 )$$

$$δ X = [ \begin{matrix}{e}_{radial} & \text{?} & {e}_{cross}\end{matrix} ] \cdot δ 0 , \qquad ( 11 )$$

$$\text{?} \text{indicates text missing or illegible when filed}$$

where

r=X_{broadcast} is a broadcast ephemeris satellite position vector, \hat{r}=\dot{X}_{broadcast} is a broadcast ephemeris satellite speed vector, δ0 is an orbit correction vector obtained in a PPP-B2b message, which is separately the components in the radial direction, the tangential direction, and the normal direction of the orbit.

The parameter included in the clock error correction message is a correction parameter relative to the broadcast ephemeris clock error, and a use method of the correction parameter is shown in formula (12):

$${t}_{satellite} = {t}_{broadcast} - \frac{{C}_{0}}{c} , \qquad ( 12 )$$

where

tₛₐₜₑₗₗᵢₜₑ is a satellite clock error obtained through correction based on the clock error correction message, t_{broadcast} is a satellite clock error parameter obtained through calculation based on the broadcast ephemeris, c is a light speed, c₀ is a clock error correction parameter obtained from the PPP-B2b message.

A corrected precise satellite orbit and a correct clock error are obtained by using the formulas (7) to (12), and precise point positioning is performed by utilizing the corrected precise satellite orbit and the corrected clock error to obtain three-dimensional coordinates and the tropospheric delay of the antenna.

A wave height and a period are obtained based on the vertical displacement that is of the GNSS antenna and that is obtained based on real-time precise point positioning, and a wave parameter is obtained through a spectrum analysis method based on a displacement time sequence, and the calculation formula is as shown in formulas (13) to (15):

$${m}_{n} = {\int }_{0}^{∞} {f}^{n} S ( f ) df , n = 0 , 1 , 2 , \qquad ( 13 )$$

$${H}_{m 0} = 4.005 \sqrt{{m}_{0}} , and \qquad ( 14 )$$

$${T}_{m} = {m}_{0} / {m}_{1} , \qquad ( 15 )$$

where

f is a frequency, s_{(f)} is a power spectral density, mₙ is an n-order spectral moment, Hₘ₀ is an significant wave height obtained through a frequency spectrum, Tₘ is an average period; and a wave period is usually 0.1-30 seconds, and therefore, a high-pass filter is used to eliminate low-frequency displacement data with a frequency lower than 0.01 Hz; and a sampling frequency of GNSS is higher than 2.5 Hz.

The three-dimensional coordinates of the GNSS antenna are resolved through real-time precise point positioning for inverting ocean waves; and the wave height and the wave period parameters are extracted from the vertical displacement through a cross-zero method and a spectrum analysis method; and a directional spectrum and a frequency spectrum of waves are obtained through the displacements in the vertical direction, east-west direction, and north-south direction of the antenna, so as to obtain element information such as the wave height, the period, and the wave direction.

The approximate mean current velocity and current direction on the sea surface are shown in the formula (5):

$$Vc = ( \sqrt{Δ {x}^{2} + Δ {y}^{2} + Δ {z}^{2} )} / Δ t \\ Dc = arctan ( \frac{- sin L \cdot Δ x + cos L \cdot Δ y}{- sin B \cdot cos L \cdot Δ x - sin B \cdot sin L \cdot Δ y + cos B \cdot Δ z} ) , \qquad ( 5 )$$

where

(Δx, Δy, Δz) is a coordinate increase of the GNSS antenna in an earth centered earth fixed coordinate system in the sliding time window, Δt is a time window length, and L and B are respectively an average longitude and an average latitude of the GNSS antenna in the sliding time window.

The current velocity and the current direction on the sea surface are inverted by utilizing the three-dimensional coordinates of the GNSS antenna that are in the earth centered earth fixed coordinate system and that are resolved through precise point positioning based on the corrected precise satellite orbit and the corrected clock error, and the approximate mean current velocity and current direction on the sea surface are resolved by utilizing the horizontal displacements and the time intervals in the east-west and north-south directions of the GNSS antenna in the sliding time window.

The atmospheric water vapor content is calculated by utilizing the zenith tropospheric delay estimated based on precise point positioning, and the formula is as shown in formula (6):

$$PWV = ( ZTD - \frac{( 2.2779 \pm 0.024 ) {P}_{1}}{1 - 0.00266 cos 2 φ - 0.00028 H} ) \frac{{10}^{6}}{( {k}_{2} + \frac{{k}_{3}}{\text{?}} ) \cdot \text{?}} , \qquad ( 6 )$$

$$\text{?} \text{indicates text missing or illegible when filed}$$

ZTD is the zenith tropospheric delay estimated based on precise point positioning of the GNSS antenna, P_{S} is atmospheric pressure (hPa) that is actually measured by the buoy or that is of a numerical weather prediction model, φ is the latitude of the buoy, H is the geodetic height (km) of the GNSS antenna, ρ_{w} is a water density, Rᵥ=461.495 J·(kg·K)−1, k₂′=(17±10) K·hPa⁻¹, k₃=(3.776±0.004) 10⁵ K²·hPa⁻¹, and Tₘ is a weighted mean temperature calculated based on the actually measured atmospheric temperature by the buoy or the numerical weather prediction model.

The atmospheric water vapor content is calculated by utilizing the zenith tropospheric delay estimated through precise point positioning based on the corrected precise satellite orbit and the corrected clock error.

Epoch-by-epoch phase difference is performed using the precise ephemeris obtained by correcting the broadcast ephemeris by using PPP-B2b, to obtain the three-dimensional velocity and the three-dimensional acceleration.

An equation for resolving the three attitude angles including the heading angle, the heading angle, and the roll angle of the GNSS single antenna based on the three-dimensional velocity and the three-dimensional acceleration of the GNSS antenna are as shown in formulas (1), (2), and (3):

$$h = \{ \begin{matrix}arc tan ( {v}_{E} / {v}_{N} ) , {v}_{E} > 0 , {v}_{N} > 0 \\ π + arc tan ( {v}_{E} / {v}_{N} ) , {v}_{N} < 0 \\ 2 π + arc tan ( {v}_{E} / {v}_{N} ) , {v}_{E} < 0 , {v}_{N} > 0\end{matrix} , \qquad ( 1 )$$

$$p = arc tan ( {v}_{U} / \sqrt{{( {v}_{E} )}^{2} + {( {v}_{N} )}^{2} )} , and \qquad ( 2 )$$

$$r = arc sin [ ( \text{?} p ) / ( \vert \text{?} \vert \vert p \vert ) ] , \qquad ( 3 )$$

$$\text{?} \text{indicates text missing or illegible when filed}$$

where

v_{U}, v_{E}, and v_{N} are respectively velocity components in the vertical, east-west and north-south directions of the buoy; and the vector 1=aⁿ−gⁿ, the vector p=g×v, aⁿ and gⁿ are respectively components of the buoy acceleration and a gravity acceleration in the normal direction of the buoy velocity.

Epoch-by-epoch phase difference is performed based on the corrected precise satellite orbit and the corrected clock error, and the attitude angles including the heading angle, the pitch angle, and the roll angle of the GNSS single antenna are resolved by utilizing the resolved three-dimensional velocity and three-dimensional acceleration of the GNSS antenna.

An equation for calculating a geodetic height of the water surface of each epoch based on the resolved geodetic height of the GNSS antenna, the attitude angles, and the lever-arm vector from the static draught GNSS antenna to the water surface is as shown in formula (4):

$$( 4 )$$

$$Hwater = Hantenna - sin ( p ) \text{?} + cos ( p ) sin ( \text{?} ) \text{?} + cos ( p ) cos ( \text{?} ) \text{?} ,$$

$$\text{?} \text{indicates text missing or illegible when filed}$$

Hwater is the water level, Hantenna is the geodetic height of the GNSS antenna, p is the pitch angle, r is the roll angle, and X_{buoy}, Y_{buoy}, and Z_{buoy} are the lever-arm vectors from the GNSS antenna to the water surface under a static draught buoy coordinate system.

The GNSS includes BeiDou, GPS, GLONASS, Galileo global navigation satellite systems, and QZSS and NAVIC regional navigation satellite systems. The free differential correction services include a precise point positioning (PPP) service space signal PPP-B2b of the Chinese BeiDou satellite or a high-accuracy service HAS (High-Accuracy Service) space signal of the EU Galileo satellite or a centimeter-level augmentation service CLAS (Centimeter-Level Augmentation Service) space signal of the Japanese QZSS satellite.

A buoy for a BeiDou/GNSS-based real-time high-accuracy sea surface measurement method includes a buoy carrier, a GNSS receiver or board card, a carried GNSS antenna, a processor, a memory, and a communication module, where a GNSS signal collection module, namely, the receiver/board card and the antenna convert a positioning electromagnetic wave signal emitted by a GNSS satellite to a water surface into a phase, a pseudo range observation, a broadcast ephemeris, and a precise point positioning (PPP) service space signal PPP-B2b of the BeiDou satellite for sending to the processor of the buoy through a serial port; the processor runs a built-in embedded GNSS data processing and sea surface element inversion software to obtain and process a signal collected by the GNSS signal collection module, the broadcast ephemeris and the PPP-B2b signal of the BeiDou satellite in real time, to obtain a sea surface water level, a wave height, a period, a wave direction, a current velocity and a current direction on a sea surface, and atmospheric water vapor content, and store the element information into the memory, or send the element information to the communication module; and the sea surface measurement device may be any one of the buoy, a boat, and a surface carrier of an unmanned boat.

This application has the advantages: in this patent application, only one GNSS buoy is required, one GNSS positioning module, and one GNSS direct signal antenna are mounted, and no additional antenna is required, so that the GNSS antenna does not need to be kept horizontal, and a GNSS reflected signal does not need to be processed; and an attitude sensor does not need to be mounted, and no additional device is required for performing the GNSS positioning data processing method in the present invention, so that real-time positioning precision of the buoy can be better than 0.1 m.

Only one low-cost dual-frequency GNSS board card needs to be carried, and a real-time buoy position of at least decimeter-level precision can be obtained based on the GNSS observation, the broadcast ephemeris, and the BeiDou PPP-B2b signal. The real-time high-accuracy centimeter sea surface measurement result can be directly obtained based on the broadcast ephemeris that is freely broadcast and used by the GNSS satellite and the PPP-B2b signal that is freely broadcast and used by the BeiDou satellite, including high-accuracy sea surface information about a plurality of elements such as the time, the longitude, the latitude, the wave height, the wave period, the wave direction, the current velocity and the current direction on the sea surface, and the atmospheric water vapor content. The sea surface element information can be locally stored on the buoy or sent back through communication, the GNSS original observation data does not need to be stored, and the GNSS original observation data does not need to be transmitted through communication, so that an ocean monitoring range is expanded, and therefore, the buoy is commonly applicable to real-time high-accuracy sea surface measurement in offshore and distant-sea scenarios. Precise differential correction and real-time communication services thereof do not need to be additionally purchased, so that the high-cost disadvantage of additionally purchasing precise differential correction and real-time communication in an existing GNSS sea surface measurement method is overcome. Storage cost, service and communication costs are greatly reduced, so that low-cost sea surface measurement working range based on GNSS is expanded. In addition, the buoy in the method can obtain a real-time high-accuracy sea surface measurement result, and therefore has a very high practical application value.

In addition, the present invention is suitable for the PPP-B2b signal that is freely broadcast and used by the BeiDou satellite, and is also suitable for the GNSS centimeter-level augmentation service, the satellite station differential service, the precise positioning service, and the like that may be free in the future.

### BRIEF DESCRIPTION OF DRAWINGS

FIG. 1 is a schematic flowchart of a GNSS-based real-time high-accuracy sea surface measurement method according to the present invention; and

FIG. 2 is a schematic diagram of a structure of a buoy for a GNSS-based real-time high-accuracy sea surface measurement method according to the present invention.

### DETAILED DESCRIPTION OF EMBODIMENTS

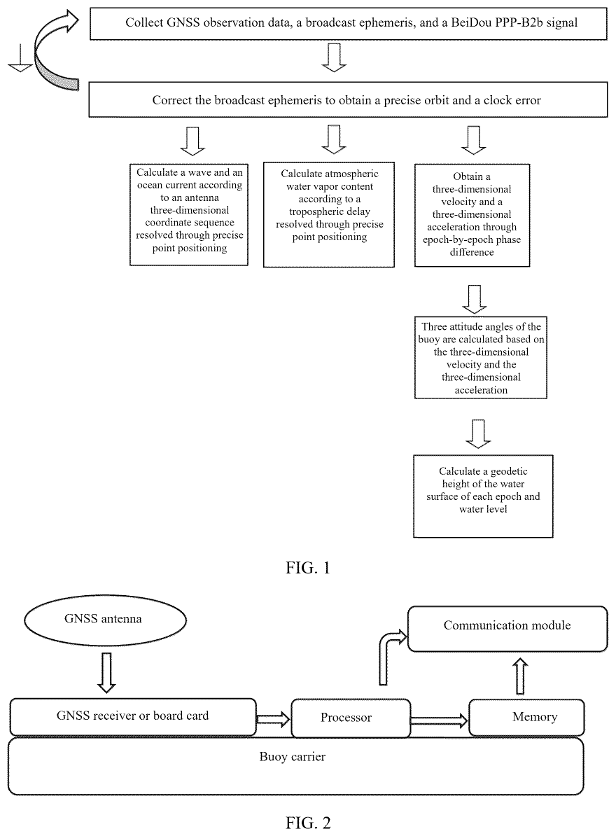

Embodiment 1 is shown in FIG. 2. A buoy carried with a dual-frequency or multi-frequency GNSS is adopted to collect a signal of the BeiDou satellite in real time, convert the signal into a phase, a pseudo range observation, a broadcast ephemeris and a correction number of a precise point positioning (PPP) service space signal PPP-B2b to send to a processor of the buoy; a corrected GNSS precise satellite orbit, a corrected clock error, a corrected pseudo range bias, and the like are obtained in real time through calculation; and precise point positioning resolving is performed to obtain a longitude, a latitude, a geodetic height and a tropospheric delay of each epoch of the GNSS antenna in real time for considering processing an atmospheric delay error. Steps (1) to (3) are repeated for 10-30 minutes to complete initial convergence of precise point positioning; the steps (1) to (3) are repeated in a sliding time window of 15-30 minutes for resolving the longitude, the latitude, the geodetic height and the tropospheric delay of each epoch of the GNSS antenna, so as to obtain a wave height and period element information based on the geodetic height of each epoch of the GNSS antenna; or a cross spectrum is calculated through a cross-correlation function based on displacements in vertical, east-west, and north-south directions of the GNSS antenna; a direction spectrum and a frequency spectrum of the ocean waves are obtained through a directional spectrum analysis method, so as to obtain a wave height, a period, and a wave direction; and an approximate mean current velocity and current direction on a sea surface are resolved by utilizing horizontal displacements and time intervals in east-west and north-south directions of the GNSS antenna within the sliding time window. Atmospheric water vapor content is obtained based on a zenith tropospheric delay estimated based on precise point positioning; a three-dimensional velocity and a three-dimensional acceleration of the GNSS antenna are obtained through a phase epoch-difference observation equation by utilizing the precise satellite orbit and clock error that are calculated in real time; attitude angles including a heading angle, a pitch angle, and a roll angle are resolved by using the GNSS single antenna; a geodetic height of each epoch is calculated, to obtain a water level based on the geodetic height of the GNSS antenna, the attitude angles, and a lever-arm vector from a static draught GNSS antenna to a water surface; and sea surface element information that is of sliding time window periods and that is calculated in real time is locally stored on the buoy or performing real-time regular communication retransmission. A working or calculation process is as shown in FIG. 1:

In a first step, GNSS observation data, a broadcast ephemeris, and a BeiDou PPP-B2b signal are collected.

In a second step, the broadcast ephemeris is corrected by using the formulas (7) to (12) to obtain a precise ephemeris.

In a third step, precise point positioning is performed to resolve three-dimensional coordinates of an antenna, and a tropospheric delay.

In the third step, there is a parallel relationship. Waves are calculated by using the formulas (13) to (15) based on the resolved three-dimensional coordinates of the antenna; ocean current is calculated by using the formula (5) based on the resolved three-dimensional coordinates of the antenna; atmospheric water vapor content is calculated by using the formula (6) based on the resolved tropospheric delay; and a three-dimensional velocity and a three-dimensional acceleration are resolved by utilizing the precise ephemeris obtained by correcting the broadcast ephemeris, and epoch-by-epoch phase difference.

In a fourth step, three attitude angles of the buoy are calculated by using the formulas (1) to (3) based on the three-dimensional velocity and the three-dimensional acceleration.

In a fifth step, a geodetic height of each epoch of the water surface is calculated by using the formula (4), to calculate a water level.

### Embodiment 2

Another GNSS system, for example, Galileo is adopted. The process is completely the same, and a difference only lies in that the BeiDou is replaced with Galileo, the precise point positioning (PPP) service space signal PPP-B2b of the BeiDou satellite is replaced with the High-accuracy service HAS (High-Accuracy Service) space signal of the Galileo satellite. Specific steps are the same as those in Embodiment 1.

1. A BeiDou/GNSS-based real-time high-accuracy sea surface measurement method, comprising the following steps:
(1) adopting a buoy carried with a dual-frequency or multi-frequency GNSS to collect a high-frequency GNSS satellite positioning electrometric wave signal and a precise point positioning (PPP) service space signal PPP-B2b of the BeiDou satellite in real time, converting the high-frequency GNSS satellite positioning electrometric wave signal and the precise point positioning (PPP) service space signal of the BeiDou satellite into a phase, a pseudo range observation, a broadcast ephemeris and a correction number thereof, and sending the phase, the pseudo range observation, the broadcast ephemeris and the correction number thereof to a processor of the buoy;
(2) calculating in real time based on the broadcast ephemeris and the correction number thereof to obtain a GNSS precise satellite orbit, a clock error, and a pseudo range bias, performing precise point positioning resolving, and resolving a longitude, a latitude, a geodetic height and a tropospheric delay of each epoch of a GNSS single antenna for considering processing an atmospheric delay error;
(3) returning to repeat steps (1) and (2) for 10-30 minutes to reach a specific data volume until initial convergence of precise point positioning is completed;
(4) resolving the longitude, the latitude, the geodetic height and the tropospheric delay of each epoch of the GNSS antenna in real time through precise point positioning; obtaining atmospheric water vapor content based on a zenith tropospheric delay estimated based on precise point positioning; resolving a three-dimensional velocity and a three-dimensional acceleration of the GNSS antenna through a phase epoch-difference observation equation by utilizing the precise satellite orbit and the clock error that are calculated in real time, resolving attitude angles including a heading angle, a pitch angle, and a roll angle by using the GNSS single antenna, and calculating the geodetic height of each epoch, to obtain a water level based on the geodetic height of the GNSS antenna, the attitude angles, and a lever-arm vector from a static draught GNSS antenna to a water surface;
(5) repeating the steps (1) to (4) by using a sliding time window of 15-30 minutes, obtaining a wave height and period element information based on the geodetic height of each epoch of the GNSS antenna, or calculating a cross spectrum through a cross-correlation function based on displacements in vertical, east-west, and north-south directions of the GNSS antenna, then, obtaining a direction spectrum and a frequency spectrum of the ocean waves through a directional spectrum analysis method, so as to obtain a wave height, a period, and a wave direction; and obtaining an approximate mean current velocity and current direction on a sea surface by utilizing horizontal displacements and time intervals in east-west and north-south directions of the GNSS antenna within the sliding time window; and
(6) locally storing sea surface element information that is of sliding time window periods and that is calculated in real time on the buoy or performing real-time regular communication retransmission.

2. The BeiDou/GNSS-based real-time high-accuracy sea surface measurement method according to claim 1, wherein a corrected broadcast ephemeris is obtained by utilizing the BeiDou PPP-B2b signal, and parameters comprised in the satellite orbit and the clock error information of the corrected broadcast ephemeris are components of an orbit correction vector δ0 in a radial direction, a tangential direction, and a normal direction; and an orbit correction value is used to calculate a satellite position correction vector δX, and by jointly utilizing a satellite position vector X_{broadcast} that is calculated from the broadcast ephemeris, the correction value calculation formula is as shown in formula (7):
$${X}_{orbit} = {X}_{broadcast} - δ X , \qquad ( 7 )$$
X_{orbit} is a satellite position obtained through correction based on an orbit correction message, X_{broadcast} is a satellite position calculated and obtained based on the broadcast ephemeris whose IOD is matched with IODN of the orbit correction message, and δX is a satellite position correction value;
a calculation method for the satellite position correction value δX is shown in formula (8) to formula (11):
$$\text{?} = \frac{\text{?}}{\vert \text{?} \vert} , \qquad ( 8 )$$
$$\text{?} = \frac{\text{?} \times \text{?}}{\vert \text{?} \times \text{?} \vert} , \qquad ( 9 )$$
$$\text{?} = \text{?} \times \text{?} , and \qquad ( 10 )$$
$$\text{?} = [ \begin{matrix}\text{?} & \text{?} & \text{?}\end{matrix} ] \text{?} , \qquad ( 11 )$$
$$\text{?} \text{indicates text missing or illegible when filed}$$
wherein
r=X_{broadcast} is a broadcast ephemeris satellite position vector, \hat{r}=\dot{X}_{broadcast} is a broadcast ephemeris satellite speed vector, δ0 is an orbit correction vector obtained in a PPP-B2b message, which is separately the components in the radial direction, the tangential direction, and the normal direction of the orbit;
the parameter comprised in the clock error correction message is a correction parameter relative to the broadcast ephemeris clock error, and a use method of the correction parameter is shown in formula (12):
$${t}_{satellite} = {t}_{broadcast} - \frac{\text{?}}{c} , \qquad ( 12 )$$
$$\text{?} \text{indicates text missing or illegible when filed}$$
wherein
tₛₐₜₑₗₗᵢₜₑ is a satellite clock error obtained through correction based on the clock error correction message, t_{broadcast} is a satellite clock error parameter obtained through calculation based on the broadcast ephemeris, c is a light speed, and c₀ is a clock error correction parameter obtained from the PPP-B2b message; and
a corrected precise satellite orbit and a correct clock error are obtained by using the formulas (7) to (12), and precise point positioning is performed by utilizing the corrected precise satellite orbit and the corrected clock error to resolve three-dimensional coordinates and the tropospheric delay of the antenna.

3. The BeiDou/GNSS-based real-time high-accuracy sea surface measurement method according to claim 1, wherein a wave height and a period are obtained based on the vertical displacement that is of the GNSS antenna and that is obtained based on real-time precise point positioning, and a wave parameter is obtained through a spectrum analysis method based on a displacement time sequence, and the calculation formula is as shown in formulas (13) to (15):
$${m}_{n} = \text{?} {f}^{n} S ( f ) df , n = 0 , 1 , 2 , \qquad ( 13 )$$
$${H}_{m 0} = 4.005 \sqrt{{m}_{0}} , and \qquad ( 14 )$$
$${T}_{m} = {m}_{0} / \text{?} , \qquad ( 15 )$$
$$\text{?} \text{indicates text missing or illegible when filed}$$
wherein
f is a frequency, s_{(f)} is a power spectral density, mₙ is an n-order spectral moment, Hₘ₀ is an significant wave height obtained through a frequency spectrum, Tₘ is an average period; and a wave period is usually 0.1-30 seconds, and therefore, a high-pass filter is used to eliminate low-frequency displacement data with a frequency lower than 0.01 Hz; and a sampling frequency of GNSS is higher than 2.5 Hz.

4. The BeiDou/GNSS-based real-time high-accuracy sea surface measurement method according to claim 1, wherein an approximate mean current velocity and current direction on the sea surface are shown in the formula (5):
$$\text{?} = ( \sqrt{\text{?}} ) / Δ \text{?} \qquad ( 5 )$$
$$\text{?} = arc tan ( \frac{- \text{?} + cos \text{?}}{- sin B \text{?} cos \text{?} - \text{?}} ) ,$$
$$\text{?} \text{indicates text missing or illegible when filed}$$
wherein
(Δx, Δy, Δz) is a coordinate increase of the GNSS antenna in an earth centered earth fixed coordinate system in the sliding time window, Δt is a time window length, and L and B are respectively an average longitude and an average latitude of the GNSS antenna in the sliding time window.

5. The BeiDou/GNSS-based real-time high-accuracy sea surface measurement method according to claim 1, wherein atmospheric water vapor content is calculated by utilizing the zenith tropospheric delay estimated based on precise point positioning, and the formula is as shown in formula (6):
$$PWV ( ZTD \text{?} \frac{( 2.2779 \pm 0.0024 ) \text{?}}{1 - 0.00266 cos \text{?} - 0.0028 H} ) \frac{{10}^{6}}{( \text{?} ) \text{?}} , \qquad ( 6 )$$
$$\text{?} \text{indicates text missing or illegible when filed}$$
wherein
ZTD is the zenith tropospheric delay estimated based on precise point positioning of the GNSS antenna, P_{S} is atmospheric pressure (hPa) that is actually measured by the buoy or that is of a numerical weather prediction model, (p is the latitude of the buoy, H is the geodetic height (km) of the GNSS antenna, ρ_{w} is a water density, Rᵥ=461.495 J·(kg·K)⁻¹, k₂′=(17±10) K·hPa⁻¹, k₃=(3.776±0.004) 10⁵ K²·hPa⁻¹, and Tₘ is a weighted mean temperature calculated based on the actually measured atmospheric temperature by the buoy or the numerical weather prediction model.

6. The BeiDou/GNSS-based real-time high-accuracy sea surface measurement method according to claim 1, wherein epoch-by-epoch phase difference is performed using the precise ephemeris obtained by correcting the broadcast ephemeris by using PPP-B2b, to obtain the three-dimensional velocity and the acceleration.

7. The BeiDou/GNSS-based real-time high-accuracy sea surface measurement method according to claim 6, wherein an equation for resolving the three attitude angles including the heading angle, the pitch angle, and the roll angle of the GNSS single antenna based on the three-dimensional velocity and the acceleration of the GNSS antenna are as shown in formulas (1), (2), and (3):
$$h = \{ \begin{matrix}arc tan ( {v}_{E} / {v}_{N} ) , {v}_{E} > 0 , {v}_{N} > 0 \\ π + arc tan ( {v}_{E} / {v}_{N} ) , {v}_{N} < 0 \\ 2 π + arc tan ( {v}_{E} / {v}_{N} ) , {v}_{E} < 0 , {v}_{N} > 0\end{matrix} , \qquad ( 1 )$$
$$p = arc tan ( {v}_{U} / \sqrt{{( {v}_{E} )}^{2} + {( {v}_{N} )}^{2} )} , and \qquad ( 2 )$$
$$r = arc sin [ ( \text{?} p ) / ( \vert \text{?} \vert \vert p \vert ) ] , \qquad ( 3 )$$
$$\text{?} \text{indicates text missing or illegible when filed}$$
wherein
v_{U}, v_{E}, and v_{N} are respectively velocity components in the vertical, east-west and north-south directions of the buoy; and the vector 1=aⁿ−gⁿ, the vector p=g×v, aⁿ and gⁿ are respectively components of the buoy acceleration and a gravity acceleration in the normal direction of the buoy velocity.

8. The BeiDou/GNSS-based real-time high-accuracy sea surface measurement method according to claim 7, wherein an equation for calculating a geodetic height of the water surface of each epoch based on the resolved geodetic height of the GNSS antenna, the attitude angles, and the lever-arm vector from the static draught GNSS antenna of the buoy to the water surface is as shown in formula (4):
$$( 4 )$$
$$Hwater = Hantenna - sin ( p ) \text{?} + cos ( p ) sin ( \text{?} ) \text{?} + cos ( p ) cos ( \text{?} ) \text{?} ,$$
$$\text{?} \text{indicates text missing or illegible when filed}$$
wherein
Hwater is the water level, Hantenna is the geodetic height of the GNSS antenna, p is the pitch angle, r is the roll angle, and X_{buoy}, Y_{buoy}, and Z_{buoy} are the lever-arm vectors from the GNSS antenna to the water surface under the static draught buoy coordinate system.

9. The BeiDou/GNSS-based real-time high-accuracy sea surface measurement method according to claim 1, wherein the GNSS comprises BeiDou, GPS, GLONASS, Galileo global navigation satellite systems, and a QZSS, NAVIC regional navigation satellite systems and free differential correction services comprise a precise point positioning (PPP) service space signal PPP-B2b of the Chinese BeiDou satellite or a high-accuracy service HAS (High-Accuracy Service) space signal of the EU Galileo satellite or a centimeter-level augmentation service CLAS (Centimeter-Level Augmentation Service) space signal of the Japanese QZSS satellite.

10. A buoy for a BeiDou/GNSS-based real-time high-accuracy sea surface measurement method, comprising a buoy carrier, a GNSS receiver or board card, a carried GNSS antenna, a processor, a memory, and a communication module, wherein a GNSS signal collection module, namely, the receiver/board card and the antenna convert a positioning electromagnetic wave signal emitted by a GNSS satellite to a water surface into a phase, a pseudo range observation, a broadcast ephemeris, and a precise point positioning (PPP) service space signal PPP-B2b of the BeiDou satellite for sending to the processor of the buoy through a serial port; the processor runs a built-in embedded GNSS data processing and sea surface element inversion software to obtain and process a signal collected by the GNSS signal collection module, the broadcast ephemeris and the PPP-B2b signal of the BeiDou satellite in real time, to obtain a sea surface water level, a wave height, a period, a wave direction, a current velocity and a current direction on a sea surface, and atmospheric water vapor content, and store the element information into the memory, or send the element information to the communication module; and the sea surface measurement device may be any one of the buoy, a boat, and a surface carrier of an unmanned boat.

11. The BeiDou/GNSS-based real-time high-accuracy sea surface measurement method according to claim 2, wherein a wave height and a period are obtained based on the vertical displacement that is of the GNSS antenna and that is obtained based on real-time precise point positioning, and a wave parameter is obtained through a spectrum analysis method based on a displacement time sequence, and the calculation formula is as shown in formulas (13) to (15):
$${m}_{n} = \text{?} {f}^{n} S ( f ) df , n = 0 , 1 , 2 , \qquad ( 13 )$$
$${H}_{m 0} = 4.005 \sqrt{{m}_{0}} , and \qquad ( 14 )$$
$${T}_{m} = {m}_{0} / \text{?} , \qquad ( 15 )$$
$$\text{?} \text{indicates text missing or illegible when filed}$$
wherein
f is a frequency, s_{(f)} is a power spectral density, mₙ is an n-order spectral moment, Hₘ₀ is an significant wave height obtained through a frequency spectrum, Tₘ is an average period; and a wave period is usually 0.1-30 seconds, and therefore, a high-pass filter is used to eliminate low-frequency displacement data with a frequency lower than 0.01 Hz; and a sampling frequency of GNSS is higher than 2.5 Hz.

12. The BeiDou/GNSS-based real-time high-accuracy sea surface measurement method according to claim 2, wherein an approximate mean current velocity and current direction on the sea surface are shown in the formula (5):
$$\text{?} = ( \sqrt{\text{?}} ) / Δ \text{?} \qquad ( 5 )$$
$$\text{?} = arc tan ( \frac{- \text{?} + cos \text{?}}{- sin B \text{?} cos \text{?} - \text{?}} ) ,$$
$$\text{?} \text{indicates text missing or illegible when filed}$$
wherein
(Δx, Δy, Δz) is a coordinate increase of the GNSS antenna in an earth centered earth fixed coordinate system in the sliding time window, Δt is a time window length, and L and B are respectively an average longitude and an average latitude of the GNSS antenna in the sliding time window.

13. The BeiDou/GNSS-based real-time high-accuracy sea surface measurement method according to claim 2, wherein atmospheric water vapor content is calculated by utilizing the zenith tropospheric delay estimated based on precise point positioning, and the formula is as shown in formula (6):
$$PWV ( ZTD \text{?} \frac{( 2.2779 \pm 0.0024 ) \text{?}}{1 - 0.00266 cos \text{?} - 0.0028 H} ) \frac{{10}^{6}}{( \text{?} ) \text{?}} , \qquad ( 6 )$$
$$\text{?} \text{indicates text missing or illegible when filed}$$
ZTD is the zenith tropospheric delay estimated based on precise point positioning of the GNSS antenna, P_{S} is atmospheric pressure (hPa) that is actually measured by the buoy or that is of a numerical weather prediction model, φ is the latitude of the buoy, H is the geodetic height (km) of the GNSS antenna, ρ_{w} is a water density, Rᵥ=461.495 J·(kg·K)⁻¹, k₂′=(17±10) K·hPa⁻¹, k₃=(3.776±0.004) 10⁵K²·hPa⁻¹, and Tₘ is a weighted mean temperature calculated based on the actually measured atmospheric temperature by the buoy or the numerical weather prediction model.

14. The BeiDou/GNSS-based real-time high-accuracy sea surface measurement method according to claim 2, wherein epoch-by-epoch phase difference is performed using the precise ephemeris obtained by correcting the broadcast ephemeris by using PPP-B2b, to obtain the three-dimensional velocity and the acceleration.

15. The BeiDou/GNSS-based real-time high-accuracy sea surface measurement method according to claim 14, wherein an equation for resolving the three attitude angles including the heading angle, the pitch angle, and the roll angle of the GNSS single antenna based on the three-dimensional velocity and the acceleration of the GNSS antenna are as shown in formulas (1), (2), and (3):
$$h = \{ \begin{matrix}arc tan ( {v}_{E} / {v}_{N} ) , {v}_{E} > 0 , {v}_{N} > 0 \\ π + arc tan ( {v}_{E} / {v}_{N} ) , {v}_{N} < 0 \\ 2 π + arc tan ( {v}_{E} / {v}_{N} ) , {v}_{E} < 0 , {v}_{N} > 0\end{matrix} , \qquad ( 1 )$$
$$p = arc tan ( {v}_{U} / \sqrt{{( {v}_{E} )}^{2} + {( {v}_{N} )}^{2} )} , and \qquad ( 2 )$$
$$r = arc sin [ ( \text{?} p ) / ( \vert \text{?} \vert \vert p \vert ) ] , \qquad ( 3 )$$
$$\text{?} \text{indicates text missing or illegible when filed}$$
wherein
v_{U}, v_{E}, and v_{N} are respectively velocity components in the vertical, east-west and north-south directions of the buoy; and the vector 1=aⁿ−gⁿ, the vector p=g×v, aⁿ and gⁿ are respectively components of the buoy acceleration and a gravity acceleration in the normal direction of the buoy velocity.

16. The BeiDou/GNSS-based real-time high-accuracy sea surface measurement method according to claim 15, wherein an equation for calculating a geodetic height of the water surface of each epoch based on the resolved geodetic height of the GNSS antenna, the attitude angles, and the lever-arm vector from the static draught GNSS antenna of the buoy to the water surface is as shown in formula (4):
$$( 4 )$$
$$Hwater = Hantenna - sin ( p ) \text{?} + cos ( p ) sin ( \text{?} ) \text{?} + cos ( p ) cos ( \text{?} ) \text{?} ,$$
$$\text{?} \text{indicates text missing or illegible when filed}$$
wherein
Hwater is the water level, Hantenna is the geodetic height of the GNSS antenna, p is the pitch angle, r is the roll angle, and X_{buoy}, Y_{buoy}, and Z_{buoy} are the lever-arm vectors from the GNSS antenna to the water surface under the static draught buoy coordinate system.
